(19) United States
(12) Patent Application Publication
(10) Pub. No.: US 2017/0358898 A1
(43) Pub. Date: Dec. 14, 2017

(54) LASER APPARATUS AND MANUFACTURING METHOD THEREOF

(71) Applicant: INTER-UNIVERSITY RESEARCH INSTITUTE CORPORATION NATIONAL INSTITUTES OF NATURAL SCIENCES, Tokyo (JP)

(72) Inventors: Takunori TAIRA, Okazaki-shi (JP); Arvydas KAUSAS, Okazaki-shi (JP); Lihe ZHENG, Okazaki-shi (JP); Vincent YAHIA, Okazaki-shi (JP); Ryo YASUHARA, Toki-shi (JP)

(73) Assignee: INTER-UNIVERSITY RESEARCH INSTITUTE CORPORATION NATIONAL INSTITUTES OF NATURAL SCIENCES, Tokyo (JP)

(21) Appl. No.: 15/609,932

(22) Filed: May 31, 2017

(30) Foreign Application Priority Data
Jun. 10, 2016 (JP) 2016-116603

(51) Int. Cl. H01S 3/04; H01S 3/042; H01S 3/16; H01S 3/11; H01S 3/08; H01S 3/06

(52) U.S. Cl. CPC H01S 3/0405; H01S 3/08059; H01S 3/0604; H01S 3/1643; H01S 3/11; H01S 3/1611; H01S 3/0621; H01S 3/042

(57) ABSTRACT

A technique which is suitable in joining an end surface of a laser medium to a transparent heat sink for maintaining thermal resistance therebetween low and avoiding large thermal stress from acting on the laser medium is to be provided. An end coat is provided on the end surface of the laser medium, a same-material layer constituted of a same material as the heat sink is provided on a surface of the end coat, a surface of the same-material layer and an end surface of the heat sink are activated in a substantially vacuum environment, and those activated surfaces are bonded in the substantially vacuum environment. A laser apparatus having low thermal resistance between the laser medium and the heat sink and high transparency at a joint interface therebetween, and no large thermal stress acting on the laser medium is thereby obtained.

### TECHNICAL FIELD

The description herein discloses a laser apparatus (including laser oscillator and laser amplifier) utilizing solid-state laser medium (or gain medium) and a manufacturing method thereof.

### BACKGROUND ART

A solid-state material which emits light when excitation beam enters therein is known. For example, a solid-state material with rare earth element dopants such as Nd:YAG, Yb:YAG, Nd:YVO₄, Yb:YVO₄, Nd:(s-)FAP, Yb:(s-)FAP emits light when the excitation beam enters therein. When such a solid-state material is installed in a laser oscillator, laser beam is discharged from the laser oscillator. The description herein refers to a solid-state material capable of receiving excitation beam and discharging laser beam from a laser oscillator as a laser medium. Further, a solid-state material that receives excitation beam and input beam to discharge output beam with amplified power of the input beam is also known. The description herein also refers to this type of solid-state material as a laser medium.

A laser medium under operation generates heat, thus it requires cooling. U.S. Pat. No. 5,796,766 discloses an apparatus provided with a function to cool a laser medium. The technique of U.S. Pat. No. 5,796,766 shapes the laser medium into a disk, and transfers heat from the laser medium to a transparent heat sink that is also shaped into a disk. The description herein refers to one flat surface of the disk-shaped laser medium as a first end surface, and another fat surface thereof as a second end surface. The technique of U.S. Pat. No. 5,796,766 contacts a disk-shaped first heat sink to the first end surface of the disk-shaped laser medium and also contacts a disk-shaped second heat sink to the second end surface of the disk-shaped laser medium to cool the laser medium from both of the first and second end surfaces.

### SUMMARY

U.S. Pat. No. 5,796,766 introduces various methods for contacting a laser medium and a heat sink, such as (1) a method of maintaining contact between those members by mechanical force (which is expressed as “optical contact” in U.S. Pat. No. 5,796,766), (2) a method of adhering the members by adhesive, (3) a method of fixing the members by epoxy resin, and (4) a method of bonding the members by diffusion bonding.

Studies conducted by the inventors have revealed that the methods (1) to (3) cannot sufficiently cool the laser medium due to thermal resistance being too high between the laser medium and the heat sink. That is, it has been revealed that an intensity of laser beam that can be outputted from the laser medium cannot be increased to a required level. This is because the method (1) is in deficit of contact area, and layers of adhesive and epoxy resin work as thermal resistance in the methods (2) and (3). According to the method of (4), although the thermal resistance between the laser medium and the heat sink can sufficiently be reduced, strong thermal stress is generated in the laser medium after bonding due to high temperature used in the diffusion bonding and a difference in thermal expansion coefficients of the laser medium and the heat sink, which reduces a light emitting performance of the laser medium, and thus alters an optical property of emitted light to something that was not intended.

The description herein discloses a technique that implements a laser apparatus having low thermal resistance between a laser medium and a heat sink, and in which strong thermal stress does not act upon the laser medium after bonding it with the heat sink.

(Manufacturing Method of Laser Apparatus)

This method manufactures a laser apparatus including a laser medium configured to emit light when excitation beam enters therein, and a heat sink having a higher thermal conductivity than the laser medium and configured to allow the excitation beam to permeate (which means that the excitation beam passes therethrough while maintaining its intensity. The same applies hereafter), the laser apparatus having an end surface of the laser medium joined with an end surface of the heat sink. This method includes: forming a reflectance property adjusting coat (hereinbelow referred to as end coat for simplicity of description) on the end surface of one of the laser medium and the heat sink; forming a same-material layer on a surface of the end coat, the same-material layer being constituted of a same material as another of the laser medium and the heat sink; activating a surface of the same-material layer and the end surface of the other of the laser medium and the heat sink in a substantially vacuum environment; and joining the activated surface of the same-material layer and the activated end surface of the other of the laser medium and the heat sink in the substantially vacuum environment.

The “activating” herein refers to a process of forming a newly-formed surface including dangling bonds. For example, it may refer to a process of forming the newly-formed surface including the dangling bonds by radiating ion beam or neutral atomic beam of Ar or the like onto a sample surface in the substantially vacuum environment, and removing oxygen or the like that had been absorbed by the surface. When activated surfaces are joined in the substantially vacuum environment, bonding force is generated by interatomic mutual effects. The description herein refers to the above process as room temperature bonding. The “substantially vacuum environment” refers to an environment, as described above, having a degree of vacuum by which the newly-formed surface can be formed by removing oxygen or other contaminant atoms from the surface, and the newly-formed surface can be maintained.

In this method, the end coat may be formed on whichever of the laser medium and the heat sink. If the end coat is to be formed on the end surface of the laser medium, the same-material layer constituted of the same material as the heat sink (hereinbelow referred to as a heat sink like layer for simplicity of description) is formed on the surface of the end coat, the surface of the heat sink like layer and the end surface of the heat sink are activated in the substantially vacuum environment, and those activated surfaces are joined in the substantially vacuum environment. As a result of this, a structure in which the laser medium, the end coat, the heat sink like layer, and the heat sink are laminated is obtained. If the end coat is to be formed on the end surface of the heat sink, the same-material layer constituted of the same material as the laser medium (hereinbelow referred to as a laser medium like layer for simplicity of description) is formed on the surface of the end coat, the surface of the laser medium like layer and the end surface of the laser medium are activated in the substantially vacuum environment, and those activated surfaces are joined in the substantially vacuum environment. As a result of this, a structure in which the heat sink, the end coat, the laser medium like layer, and the laser medium are laminated is obtained.

In describing that “the end surface of the laser medium and the end surface of the heat sink are bonded” herein, to be more specific, this refers to the end surface of the laser medium and the end surface of the heat sink are bonded via the end coat and the heat sink like layer, or via the end coat and the laser medium like layer.

(Laser Apparatus)

The description herein discloses a novel structure of a laser apparatus that comprises a laser medium configured to emit light when excitation beam enters the laser medium, and a heat sink having a higher thermal conductivity than the laser medium, configured to allow the excitation beam to permeate, and including an end surface joined with an end surface of the laser medium. This laser apparatus comprises an end coat provided between the heat sink and the laser medium, and a same-material layer intervened between the end coat and one of the heat sink and the laser medium, the same-material layer being constituted of a same material as the one of the heat sink and the laser medium but having a different crystalline state. The laser apparatus described herein includes laser oscillators and laser amplifiers.

This laser apparatus has the structure in which the laser medium, the end coat, the heat sink like layer, and the heat sink are laminated, or the structure in which the heat sink, the end coat, the laser medium like layer, and the laser medium are laminated. These structures can be manufactured by a room temperature bonding method as aforementioned, however, but are not limited thereto. Since layers with the same material are to be bonded, they can be obtained by low-temperature diffusion bonding (thus in which thermal stress acting on the laser medium is suppressed) as well.

According to the above, a laser apparatus in which the thermal resistance between the laser medium and the heat sink can be maintained low, and large thermal stress does not act on the laser medium that had been subjected to the bonding can be achieved. The laser apparatus capable of emitting high intensity laser beam that was not emitted by the known apparatus can be achieved.

(Pulse Laser Apparatus)

When the technique disclosed herein is applied to a pulse laser apparatus, the following configuration is obtained. This laser apparatus comprises a first heat sink, a laser medium, a saturable absorber, and a second heat sink arranged in this order. A second end surface (end surface on a laser medium side) of the first heat sink joins a first end surface (end surface on a first heat sink side) of the laser medium, a second end surface (end surface on a saturable absorber side) of the laser medium joins a first end surface (end surface on the laser medium side) of the saturable absorber, and a second end surface (end surface on a second heat sink side) of the saturable absorber joins a first end surface (end surface on the saturable absorber side) of the second heat sink. The saturable absorber has an absorbing ability that is configured to saturate when an intensity of light entering from the laser medium increases, which functions as a Q switch. The first heat sink has a higher thermal conductivity than the laser medium and is configured to allow excitation beam to permeate. The second heat sink has a higher thermal conductivity than the saturable absorber and is configured to allow laser beam to permeate (meaning that the laser beam passes therethrough while maintaining its intensity. The same applies hereafter). A first end coat is provided between the first heat sink and the laser medium, and a second end coat is provided between the saturable absorber and the second heat sink. A pulse laser oscillator can be implemented between the first end coat and the second end coat.

In this pulse laser apparatus, the technique disclosed herein is applied between the first heat sink and the laser medium, and between the saturable absorber and the second heat sink. As a result, a first same-material layer constituted of a same material as the one of the first heat sink and the laser medium but having a different crystalline state is intervened between the first end coat and one of the first heat sink and the laser medium. That is, the first heat sink like layer constituted of the same material as the first heat sink but having the crystalline state different therefrom is intervened between the first end coat and the first heat sink, or the laser medium like layer constituted of the same material as the laser medium but having the crystalline state different therefrom is intervened between the first end coat and the laser medium. Furthermore, a second same-material layer constituted of a same material as the one of the saturable absorber and the second heat sink but having a different crystalline state is intervened between the second end coat and one of the saturable absorber and the second heat sink. That is, the saturable absorber like layer constituted of the same material as the saturable absorber but having the crystalline state different therefrom is intervened between the second end coat and the saturable absorber, or the second heat sink like layer constituted of the same material as the second heat sink but having the crystalline state different therefrom is intervened between the second end coat and the second heat sink.

According to the above, a pulse laser apparatus can be achieved, in which thermal resistance between the laser medium and the first heat sink can be suppressed low, thermal resistance between the saturable absorber and the second heat sink can be suppressed low, large thermal stress can be suppressed from generating in the laser medium that had been subjected to the bonding, large thermal stress can be suppressed from generating in the saturable absorber that had been subjected to the bonding. Heat from the laser medium is thermally transmitted efficiently to the first heat sink that is atomically jointed to the laser medium, and is further thermally transmitted from the first heat sink. The laser medium is efficiently cooled by the first heat sink. Similarly, heat from the saturable absorber is thermally transmitted efficiently to the second heat sink that is atomically jointed to the saturable absorber, and is further thermally transmitted from the second heat sink. The saturable absorber is efficiently cooled by the second heat sink. Heat generating units of the pulse laser apparatus are effectively cooled, and laser power that the pulse laser apparatus is capable of outputting is thereby increased.

(Multilevel Laser Apparatus)

There are cases where a laser apparatus, which arranges a plurality of laser media linearly is required. When the technique disclosed herein is applied to a multilevel laser apparatus, the following configuration is obtained. This multilevel laser apparatus comprises a plurality of heat sinks and a plurality of laser media, and the each of the heat sinks and the each of the laser media are arranged alternately. Each of the laser media is configured to discharge laser beam when excitation beam enters into the laser medium. Each of the heat sinks has a higher thermal conductivity than the laser medium, and is configured transparent to the excitation beam and the laser beam (the excitation bean and the laser beam pass therethrough while maintaining their intensities). This multilevel laser oscillator has a structure in which the laser media, the end coat, the heat sink like layer, and the heat sink are laminated, or a structure in which the heat sink, the end coat, the laser medium like layer, and the laser media are laminated.

The multilevel laser apparatus may be a multilevel laser oscillator. A solid-state material that receives excitation beam and input beam (seed light) and discharges amplified beam of the input beam may be adopted as the above laser medium. By this, a multilevel laser amplifier can be formed.

In the aforementioned multilevel laser apparatus (that is, multilevel laser oscillator or multilevel laser amplifier), it is preferable that a light emitting atom density is lower for the laser medium located closer to an end surface where the excitation beam enters than a light emitting atom density for the laser medium located closer to an end surface where the laser beam discharges.

In this case, when observing along progression of the excitation beam, a relationship can be observed in which the excitation beam passes through the laser medium having the low light emitting atom density (therefore having low absorption rate) in an area where the excitation beam intensity is still high due to absorption of the excitation beam has not yet taken place, and the excitation beam passes through the laser medium having the high light emitting atom density (therefore having high absorption rate) in an area where the excitation beam intensity has dropped as a result of the excitation beam having been absorbed. A combination of high intensity and low absorption rate in the former area and a combination of low intensity and high absorption rate in the latter area present uniformized values in multiplications for the respective combinations. When a light emitting atom density for the laser medium located close to an end surface where the excitation beam enters is low, and a light emitting atom density for the laser medium located far away from the end surface where the excitation beam enters is high, temperatures of the laser media arranged in multi levels are uniformized, and a maximum temperature among the laser media can be reduced.

(Excitation Beam Multi-Reflection Laser Apparatus)

There are cases where a length of a laser medium (length along an incident direction of the excitation beam) is short, and the laser medium cannot sufficiently absorb the excitation beam. In a case of a thin plate-shaped laser medium with a short distance between an input surface of the excitation beam and an output surface of the laser beam, a problem that the laser medium cannot sufficiently absorb the excitation beam may occur. Due to this, there is a known laser apparatus provided with a reflecting mechanism for reflecting the excitation beam, which had entered into the laser medium from the input surface of the excitation beam and discharged to outside the laser medium from the input surface of the excitation beam by having been reflected on the output surface of the laser beam (which is herein referred to as excitation beam reflected in the laser medium for simplicity of description), to redirect this excitation beam towards the laser medium once again. In a conventional apparatus, a thin plate-shaped laser medium was fixed to a metal heat sink to cool the laser medium. In the conventional apparatus, interference between the metal heat sink and the excitation beam reflecting mechanism needs to be avoided, which elongates a resonator length of the laser oscillator. A technique for shortening the resonator length while allowing the use of the heat sink and the excitation beam reflecting mechanism is being in demand.

According to the technique disclosed herein, since a member through which the excitation beam permeates can be used as the heat sink, the excitation beam, which had reflected in the laser medium and is passing through the transparent heat sink, can be reflected to pass through the transparent beat sink again and be redirected towards the laser medium. Due to this, an excitation beam reflecting mechanism that is configured to reflect the excitation beam, which is passing through the heat sink after having reflected in the laser medium, to redirect the excitation beam to pass through the heat sink towards the laser medium can be employed. Due to this, the resonator length can be shortened.

### BRIEF DESCRIPTION OF DRAWINGS

FIG. 1 is a side view of a pulse laser apparatus of a first embodiment;

FIG. 2 is a disassembled perspective view of the pulse laser apparatus of the first embodiment;

FIG. 3 shows a laser medium and a heat sink before activation process;

FIG. 4 shows the laser medium and the heat sink during the activation process;

FIG. 5 shows the laser medium and the heat sink after the activation process;

FIG. 6 shows a state after the activated laser medium and the activated heat sink are brought into contact;

FIG. 7 is a side view of a multilevel laser apparatus of a second embodiment;

FIG. 8 is a side view of a multi-reflection laser apparatus of a third embodiment;

FIG. 9 is a view of optical paths of multiply-reflecting excitation beam as seen from as direction IX of FIG. 8;

FIG. 10 is a side view of the optical paths of the multiply-reflecting excitation bean;

FIG. 11 is a side view of a multi-reflection laser apparatus of a fourth embodiment; and

FIG. 12 is a side view of a multi-reflection laser apparatus of a fifth embodiment.

### DETAILED DESCRIPTION

The technique disclosed herein achieves the following aim (a), however, the following embodiments further achieve the following aims (b) and (d). Each feature that achieves the respective aim is independently useful. For example, a feature herein is useful even if it does not achieve the aim (a), should it achieve the aim (b).

(a) To provide a technique for maintaining low thermal resistance between a laser medium and a heat sink, and avoiding large thermal stress from acting on the laser medium after bonding.

(b) To provide a cooling technique suitable for a pulse laser apparatus.

(c) To provide a cooling technique suitable for a multilevel laser apparatus that arranges a plurality of laser media linearly in multiple levels.

(d) To provide a technique for shortening a resonator length in using an excitation beam reflecting mechanism that redirects excitation beam reflected in the laser medium towards the laser medium again.

A laser apparatus useful for achieving the above aim (b) may comprise the following configuration:

A first heat sink, a laser medium, a saturable absorber, and a second heat sink are arranged in this order. A second end surface (end surface on a laser medium side) of the first heat sink joins a first end surface (end surface on a first heat sink side) of the laser medium, a second end surface (end surface on a saturable absorber side) of the laser medium joins a first end surface (end surface on the laser medium side) of the saturable absorber, and a second end surface (end surface on a second heat sink side) of the saturable absorber joins a first end surface (end surface on the saturable absorber side) of the second heat sink.

The laser medium emits light when excitation beam enters therein. The saturable absorber has an absorbing ability that is configured to saturate when an intensity of light entering from the laser medium increases. The first heat sink has a higher thermal conductivity than the laser medium and is configured to allow the excitation beam to permeate therethrough. The second heat sink has a higher thermal conductivity than the saturable absorber and is configured to allow laser beam to permeate therethrough.

A first end coat is provided between the first heat sink and the laser medium. A second end coat is provided between the saturable absorber and the second heat sink. A pulse laser oscillator is configured by the first end coat, the laser medium, the saturable absorber, and the second end coat.

According to this apparatus, heat from the laser medium is thermally transmitted efficiently to the first heat sink, and is further thermally transmitted from the first heat sink. The laser medium is efficiently cooled by the first heat sink. Heat from the saturable absorber is thermally transmitted efficiently to the second heat sink, and is further thermally transmitted from the second heat sink. The saturable absorber is efficiently cooled by the second heat sink. Heat generating parts of the pulse laser apparatus are effectively cooled, and laser power that the pulse laser apparatus is capable of outputting is thereby increased.

It is preferable that a first same-material layer is intervened between the first end coat and one of the first heat sink and the laser medium, and this first same-material layer is constituted of a same material as the one of the first heat sink and the laser medium but has a different crystalline state therefrom, and a second same-material layer is intervened between the second end coat and one of the saturable absorber and the second heat sink, and this second same-material layer is constituted of a same material as the one of the saturable absorber and the second heat sink but has a different crystalline state therefrom, however, these are not mandatory.

A laser apparatus useful for achieving the above aim (c) may comprise the following configuration:

A plurality of heat sinks and a plurality of laser media are provided, and each of the heat sinks and each of the laser media are arranged alternately. The laser media are configured to emit laser beam when excitation beam enters therein. The laser media may be configured to receive excitation beam and input beam and to discharge amplified beam of the input beam. The heat sinks have a higher thermal conductivity than the laser media, and are configured to allow the excitation beam and the laser beam to permeate therethrough. An end coat is provided between respective pairs of the heat sink and the laser medium.

According to this apparatus, the heat sinks join both end surfaces of each laser medium, so each laser medium is efficiently cooled from its both end surfaces.

It is preferable that a structure in which the laser medium, the end coat, the heat sink like layer, and the heat sink are laminated is provided, or alternately a structure in which the heat sink, the end coat, the laser medium like layer, and the laser medium are laminated is provided, however, this is not mandatory.

A laser apparatus useful for achieving the above aim (d) may comprise the following configuration:

A laser medium, a heat sink, and an excitation beam reflecting mechanism are provided, and an end surface (end surface on a laser medium side) of the heat sink joins an end surface (end surface on a heat sink side) of the laser medium. The laser medium emits light when excitation beam enters therein. The heat sink has a higher thermal conductivity than the laser medium, and is configured to allow the excitation beam to permeate therethrough.

The excitation beam reflecting mechanism reflects the excitation beam, which is passing through the heat sink after having been reflected in the laser medium, to redirect the excitation beam to pass through the heat sink towards the laser medium.

It is preferable that a structure in which the laser medium, the end coat, the heat sink like layer, and the heat sink are laminated is provided, or alternately a structure in which the heat sink, the end coat, the laser medium like layer, and the laser medium are laminated is provided, however, this is not mandatory.

### EMBODIMENTS

### First Embodiment: Pulse Laser Apparatus

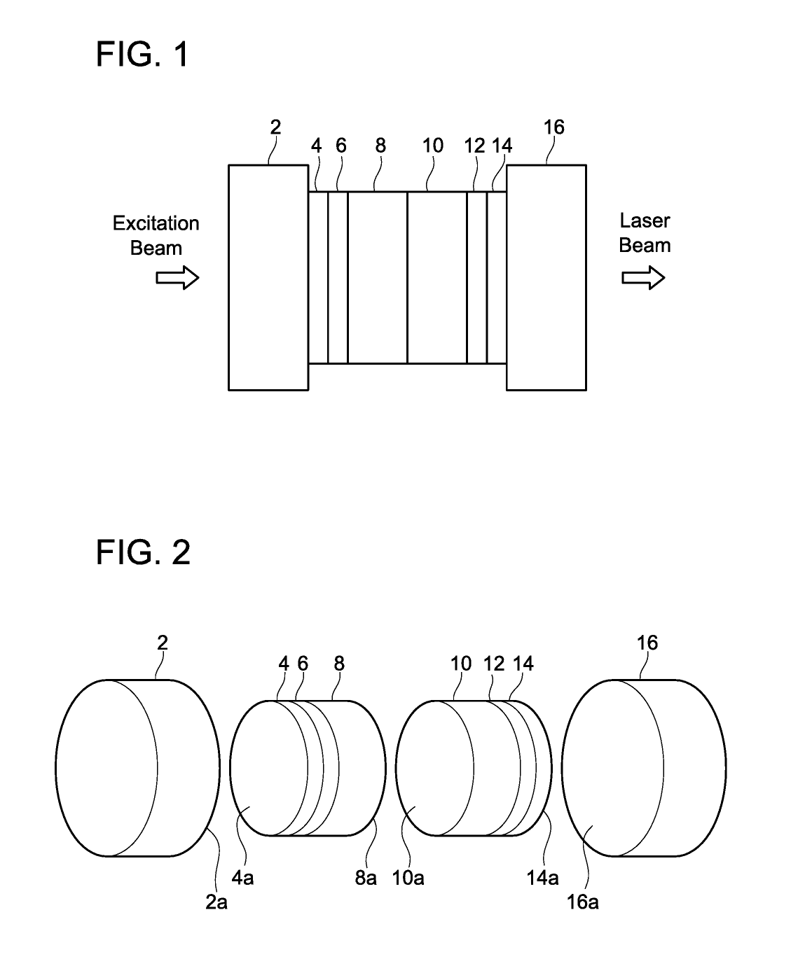

FIG. 1 shows a side view of a pulse laser apparatus of a first embodiment, and FIG. 2 is a disassembled perspective view thereof. Reference sign 2 shows a first heat sink, reference sign 8 shows a laser medium, reference sign 10 shows a saturable absorber, and reference sign 16 shows a second heat sink. The laser medium 8 emits light when excitation beam enters therein through the first heat sink 2, and pulse laser beam is discharged through the second heat sink 16.

Reference sign 6 shows a first end coat, having a low reflectance to the excitation beam and a high reflectance to the laser beam. Reference sign 12 shows a second end coat, having an intermediate reflectance to the laser beam. That is, a part of the laser beam is reflected therein and another part of the laser beam permeates therethrough.

The laser medium 8 emits light when the excitation beam enters therein. The saturable absorber 10 has an absorbing ability that is configured to saturate when an intensity of light entering from the laser medium 8 increases and becomes transparent. That is, the saturable absorber 10 turns transparent when an intensity of the laser beam trapped between the first end coat 6 and the second end coat 12 becomes large, and functions as a passive Q switch. The pulse laser beam is discharged through the second heat sink 16.

FIG. 2 shows a disassembled view of the pulse laser apparatus. The first end coat 6 is provided on an end surface (end surface on a first heat sink 2 side) of the laser medium 8, and a layer 4 constituted of a same material as the first heat sink 2 (which is hereafter referred to as a first heat sink like layer 4) is provided on a surface of the first end coat 6. Similarly, a second end coat 12 is provided on an end surface (end surface on a second heat sink 16 side) of the saturable absorber 10, and a layer 14 constituted of a same material as the second heat sink 16 (which is hereafter referred to as a second heat sink like layer 14) is provided on a surface of the second end coat 12.

In this embodiment, YAG containing 1.1 at. % Nd is used as the laser medium 8. The laser medium 8 has a disk shape with a diameter of 5 mm and a thickness of 4 mm. YAG containing Cr⁴⁺ is used for the saturable absorber 10. Light of 880 nm is used as the excitation beam. The pulse laser beam of 1064 nm is thereby achieved. A Q switch material other than Cr=YAG may be used as the saturable absorber 10. It may be a nonlinear optical element such as LBO or crystal.

In the present embodiment, the first end coat 6 and the second end coat 12 are formed by coating multilayer dielectric films. The first heat sink 2 needs to allow the excitation beam of 808 nm to permeate therethrough, and a sapphire substrate is used in the present embodiment. The second heat sink 16 needs to allow the laser beam of 1064 nm to permeate therethrough, and a sapphire substrate is used in the present embodiment.

It is difficult to maintain a thermal resistance between multilayer dielectric films (first end coat 6 and second end coat 12) and sapphire substrates low, while avoiding a large thermal stress from acting on the laser medium 8. A method of keeping the multilayer dielectric films and the sapphire substrates in contact by mechanical force cannot achieve sufficient contact areas, and the thermal resistance cannot be lowered. According to a method of adhering them by adhesive such as epoxy, a layer of such adhesive would increase the thermal resistance. When the multilayer dielectric films and the sapphire substrates are diffusion bonded, the thermal resistance would be reduced, however, a large thermal stress acts on the laser medium 8. In the present embodiment, in an attempt to avoid the aforementioned circumstances, the laser medium 8, on an end surface of which a muitilayer dielectric film (first end coat 6) is provided, and a sapphire substrate (first heat sink 2) are bonded by room temperature bonding. Further, the saturable absorber 10 on an end surface of which a multilayer dielectric film (second end coat 12) is provided, and a sapphire substrate (second heat sink 16) are bonded by room temperature bonding.

Reference sign 4 in FIG. 2 is an alumina film deposited on a surface of the first end coat (multilayer dielectric film) 6, and is a film constituted of a same material as the first heat sink (sapphire) 2. Reference sign 14 is an alumina film deposited on a surface of the second end coat (multilayer dielectric film) 12, and is a film constituted of a same material as the second heat sink (sapphire) 16. The first heat sink (sapphire) 2 and the alumina film 4 constituted of the same material are to be firmly joined in the room temperature bonding to be described later. Similarly, the second heat sink (sapphire) 16 and the alumina film 14 constituted of the same material are to be firmly joined in the room temperature bonding to be described later.

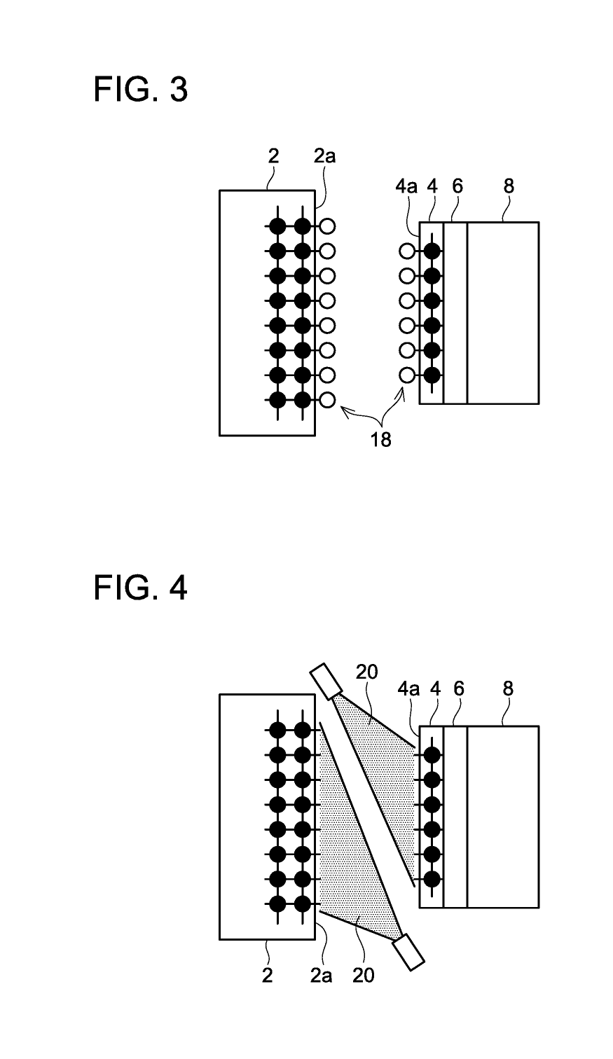

FIG. 3 shows a surface of the laser medium 8 (to be more precise, a surface 4a of the alumina film 4), on the end surface of which the first end coat (multilayer dielectric film) 6 is provided, and the film 4 of the same material (alumina) as the first heat sink 2 is provided on a surface of the first end coat (multilayer dielectric film) 6. FIG. 3 also shows a surface 2a of the first heat sink (sapphire) 2. When these are exposed to air, contaminant atoms 18 such as oxygen and the like bind onto the surfaces 4a,2a, and thus the alumina film 4 and the sapphire substrate 2 would not be joined even if they are brought into contact.

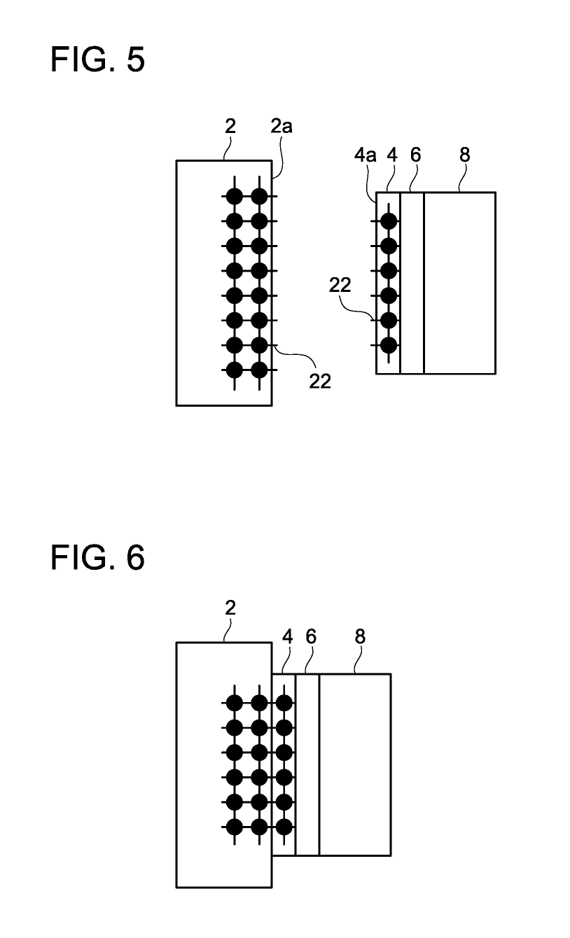

FIG. 4 shows a state in which the alumina film 4 and the sapphire substrate 2 are placed in a substantially vacuum environment, and ion beam 20 such as Ar is radiated on their surfaces. When the ion beam 20 is radiated on the surfaces, oxygen and the like that had adhered on the surfaces 4a,2a is removed, and newly-formed surfaces including dangling bonds are formed. FIG. 5 shows the surface 4a of the alumina film 4 and the surface 2a of the sapphire substrate 2 where the newly-formed surfaces are formed, and atomic bonds (dangling bonds) 22 are exposed on the surfaces. FIG. 6 shows a state in which the alumina film 4 and the sapphire substrate 2, on the surfaces of which the atomic bonds are exposed, are brought into contact, and in this state, inter-atomic mutual bonding force is generated between the alumina film 4 and the sapphire substrate 2, as a result of which the alumina film 4 and the sapphire substrate 2 are bonded firmly. The thermal resistance between the alumina film 4 and the sapphire substrate 2 is low. Further, since the alumina film 4 and the sapphire substrate 2 are bonded in room temperature, no large thermal stress would act on the laser medium 8. Furthermore, transparency at a joint interface of the alumina film 4 and the sapphire substrate 2 is extremely high, and no blur or coloring can be observed. In the present embodiment, the presence of the first end coat 6 being vapor deposited on the surface of the laser medium 8 allows the thermal resistance therebetween to be low, the presence of the layer 4 constituted of the same material as the first heat sink 2 being vapor deposited on the surface of the first end coat 6 allows the thermal resistance therebetween to be low, and the first heat sink 2 being room temperature bonded to the surface of the layer 4 constituted of the same material as the first heat sink 2 allows the thermal resistance therebetween to be low. In the present embodiment, the thermal resistance between the laser medium 8 and the first heat sink 2 is low. The first heat sink like layer 4 is a layer constituted of the same material as the first heat sink 2, but has a different crystalline state.

The same applies to a relationship of the saturable absorber 10, the second end coat 12, the second heat sink like layer 14, and the second heat sink 16, and as such, the second heat sink like layer 14 and the second heat sink 16 are room temperature bonded. In the present embodiment, the thermal resistance between the saturable absorber 10 and the second heat sink 16 is low, and no large thermal stress acts on the saturable absorber 10. Transparency at a joint interface of the saturable absorber and the heat sink is extremely high, and no blur or coloring can be observed.

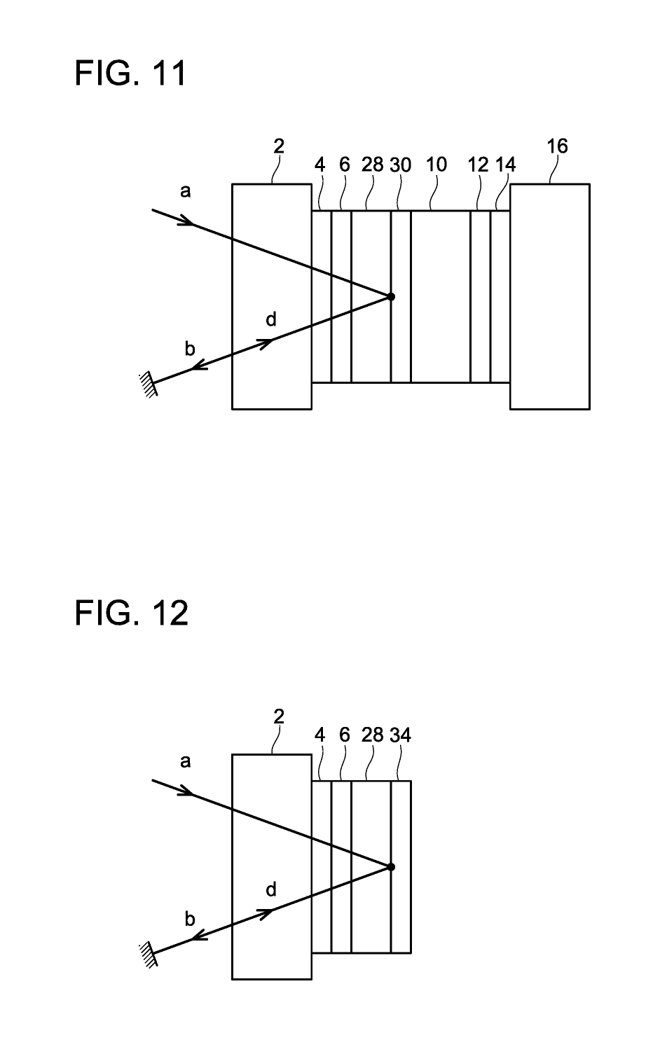

It should be noted that the laser medium 8 and the saturable absorber 10 may be room temperature bonded. If the laser medium 8 and the saturable absorber 10 are both YAGs but differ only in dopants, this means that they are same-material layers, and thus can be room temperature bonded while skipping a step to form a same-material layer. Further, as shown in FIG. 11, an end coat 30 can be intervened between laser medium 28 and saturable absorber 30. The end coat 30 is a film having a high reflectance to the excitation beam and a low reflectance to the laser beam. When the end coat 30 is to be formed on a laser medium 28, a saturable absorber like layer is formed on a surface thereof to bond to the saturable absorber 10 by room temperature bonding. When the end coat 30 is to be formed on the saturable absorber 10, a laser medium like layer is formed on a surface thereof to bond it to the laser medium 28 by room temperature bonding.

It should be noted that the first heat sink 2 and the second heat sink 16 preferably connected directly or indirectly to a heat diffusing device that is not shown.

As shown in FIGS. 1 and 2, in the present embodiment, the first end coat 6 and the first heat sink like layer 4 are formed on the end surface of the laser medium 8, and this laminate is room temperature bonded to the first heat sink 2. As an alternative thereto, the first end coat 6 and a laser medium like layer may be formed on the end surface of the first heat sink 2, and this laminate may be room temperature bonded to the laser medium 8. In the latter case, the laser medium like layer is formed between the first end coat 6 and the laser medium 8. The laser medium like layer is constituted of the same material as the laser medium 8 but has a different crystalline state. Similarly, the second end coat 12 and a saturable absorber like layer may be formed on the end surface of the second heat sink 16, and this laminate may be room temperature bonded to the saturable absorber 10. In the latter case, the saturable absorber like layer is formed between the second end coat 12 and the saturable absorber 10. The saturable absorber like layer is constituted of the same material as the saturable absorber 10 but has a different crystalline state.

### Second Embodiment: Multilevel Laser Apparatus

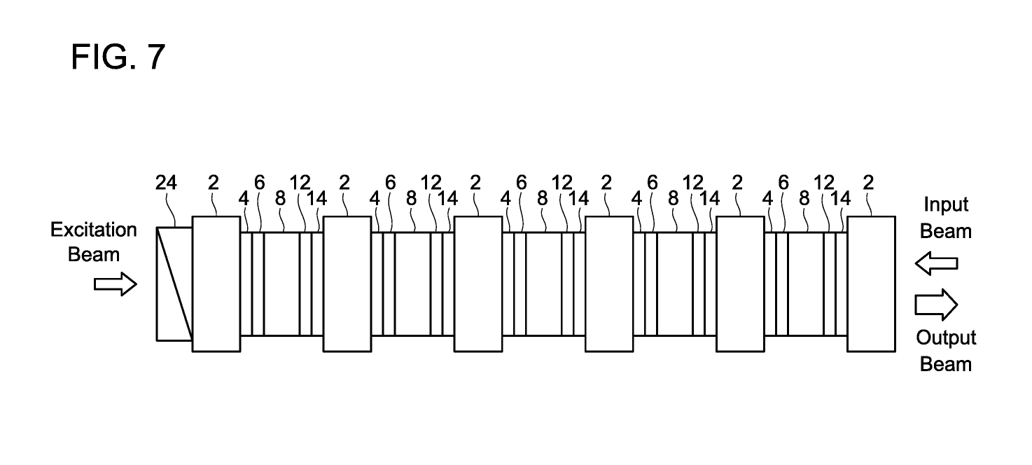

FIG. 7 shows a multilevel laser apparatus of a second embodiment, which is a multilevel laser amplifier that aligns a plurality of laser media 8 linearly in multiple levels. Each of the laser media 8 emits light when excitation beam and input beam (seed light) enter therein, and amplified laser beam of the input beam is output. Films 6 and 12 adjusted to an intermediate reflectance to laser beam are provided on both surfaces of each laser medium 8.

A heat sink 2 is inserted between each pair of adjacent laser media 8, 8. The heat sinks 2 have a higher thermal conductivity than the laser media 8, and are configured to allow the excitation beam, the input beam, and the laser beam to permeate therethrough.

Reference signs 4 and 14 show heat sink like layers intervened between the heat sinks 2 and respective ones of the end coats 6, 12, and the presence of these same-material layers allows the heat sinks 2 and the laser media 8 to be joined by room temperature bonding. Reference sign 24 is a λ/4 plate. The λ/4 plate 24 may be arranged at a right end of FIG. 7, or may be omitted. In a case of a single-path amplifier, the λ/4 plate 24 is not required. Further, a Faraday rotator may be used instead of the λ/4 plate 24.

The heat sinks 2 have a larger diameter than the laser media 8. The apparatus of FIG. 7 is used by housing it in a metal cylinder that is not shown. Thus, a relationship is obtained in which outer circumferential surfaces of the heat sinks 2 make contact with an inner circumference of the metal cylinder. Heat from the laser media 8 is effectively cooled by thermally transmitted to the metal cylinder through the heat sinks 2.

In FIG. 7, although the excitation beam enters from the left end surface, however, it may enter from both left and right surfaces. The input beam may enter from either the left and right end surfaces.

There is a case where an outermost surface of each end coat is of a same material as the heat sinks. For example, there are cases where the outermost surfaces of the end coats are alumina, and the heat sinks are sapphire. Alternately, there are cases where the outermost surfaces of the end coats are YAG, and the heat sinks are also YAG. YAG may have varied properties depending on types and amounts of dopants, and thus it may be used for the end coats as well as for the heat sinks. In this case, the outermost surfaces of the end coats may serve as same-material layers.

A solid-state material that emits light when excitation beam enters therein can be used as each of the laser media 8 shown in FIG. 7. In this case, a multilevel laser oscillator is obtained.

### Third Embodiment: Excitation Beam Multi-Reflection Laser Apparatus

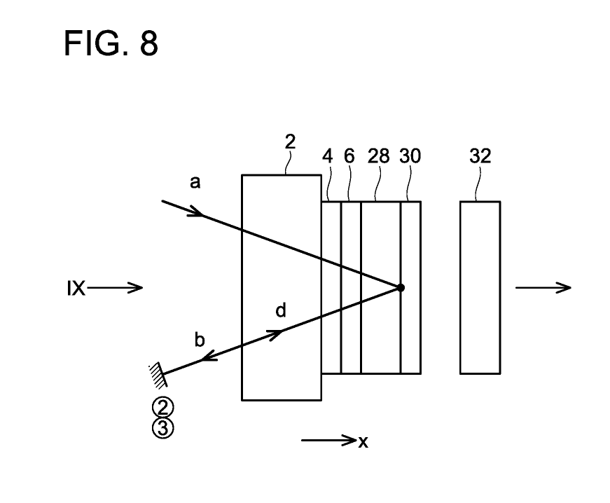

FIG. 8 shows a laser apparatus of a third embodiment, and excitation beam reflected in the laser medium 28 is reflected again to re-enter the laser medium 28. The laser medium 28 is thin (its distance along an average progressing direction of the excitation beam (x axis) is short), and as such, the excitation beam is not sufficiently absorbed by merely reciprocating within the laser medium 28 just once, thus the excitation beam is reflected in multi paths.

Reference sign 2 shows the heat sink, which is transparent to the excitation beam of 808 nm. Reference sign 4 shows the heat sink like layer, 6 shows the first end coat, 28 shows the laser medium (which is thinner than the laser medium 2 of the first and second embodiments), 30 shows the second end coat, and 32 shows an output coupler.

The first end coat 6 has a low reflectance to the excitation beam, and a high reflectance to the laser beam. The second end coat 30 has a high reflectance to the excitation beam, and a low reflectance to the laser beam.

As shown in FIG. 8, the excitation beam passes through the heat sink 2 through which the excitation beam can permeate, the heat sink like layer 4 through which the excitation beam can permeate, and the first end coat 6 through which the excitation beam can permeate, and enters into the laser medium 28. The excitation beam that has progressed within the laser medium 28 is reflected by the second end coat 30, and progresses within the laser medium 28 leftward. The excitation beam that had progressed within the laser medium 28 leftward passes through the first end coat 6 to exit the laser medium 28, and further progresses leftward within the heat sink 2. The laser medium 28 is thin, so the excitation beam cannot be sufficiently absorbed in the laser medium 28 by merely reciprocating within the laser medium 28 just once. The excitation beam “b” progressing leftward from the heat sink 2 can still be used. Thus, in the present embodiment, an excitation beam reflecting mechanism is used to redirect the excitation beam “b” towards the laser medium 28 again.

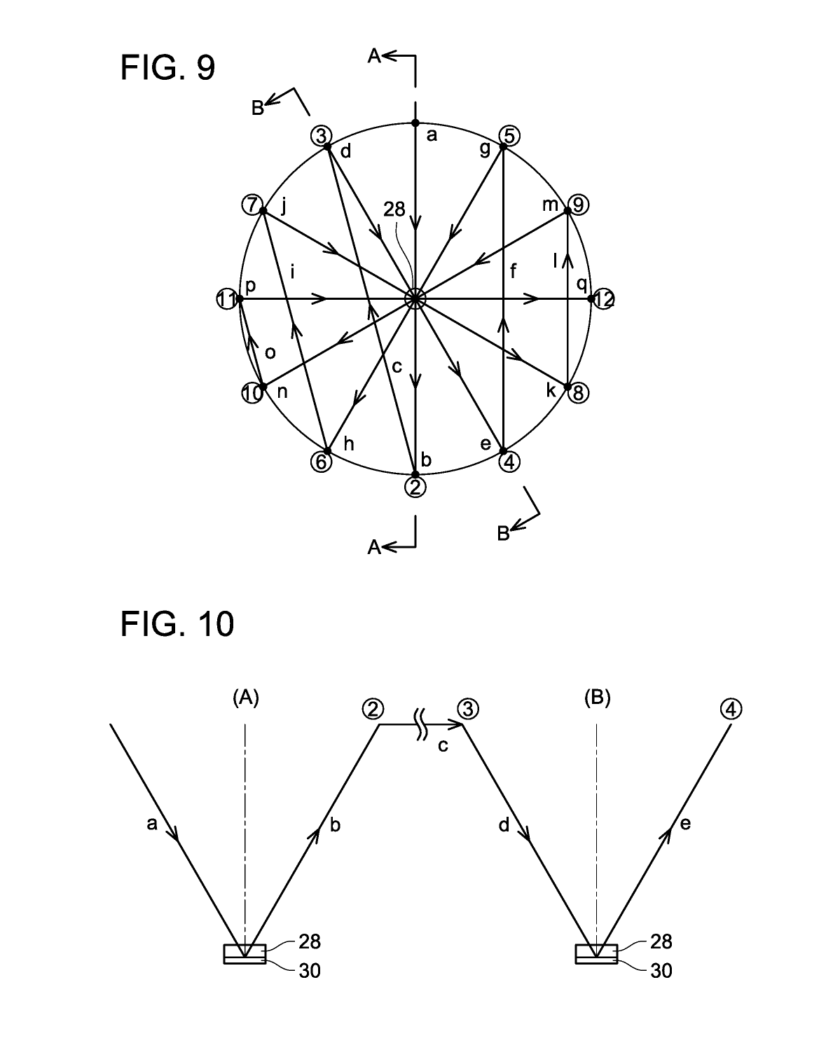

FIG. 9 is an observation of optical paths of the excitation beam that repeatedly passes through the heat sink 2 by the excitation beam reflecting mechanism as seen from an IX direction of FIG. 8.

Numbers shown in circles show reflecting points of the excitation beam by the excitation beam reflecting mechanism. The numbers show an order of reflecting positions. An alphabet “a” in FIG. 9 show the excitation beam obtained from a light emitting diode that is not shown, and other alphabets show the optical paths of the excitation beam reflected at the laser medium 28 or the reflecting points of the excitation beam reflecting mechanism. For example, the excitation beam “a” is reflected on the laser medium 28 and progresses along an optical path “b”, is reflected at a reflecting point 2 and progresses along an optical path “c”, is reflected at a reflecting point 3 and progresses along an optical path “d”, is reflected at the laser medium 28 and progresses along an optical path “e”, and is reflected at a reflecting point 4 and progresses along an optical path “f”.

FIG. 10 is a side-view observation of the optical paths of the excitation beam that repeatedly passes through the heat sink 2 by the excitation beam reflecting mechanism. However, (A) in FIG. 10 shows the optical paths in an A-A plane of FIG. 9, and (B) in FIG. 10 shows the optical paths in a B-B plane of FIG. 9. In the case of FIG. 8, the optical path “b” shows the optical paths in the A-A plane, and the optical path “d” shows an overlap of the optical paths in the B-B plane.

As it is apparent from FIGS. 9 and 10, in the present embodiment, the excitation beam arrives in the laser medium 28 six times (optical paths a, d, g, j, m, p) by the excitation beam reflecting mechanism. Although the laser medium 28 is thin, the excitation beam is absorbed to its required amount while it reciprocates six times therein, and the laser beam with a required intensity is discharged.

In the conventional laser apparatus provided with an excitation beam reflecting mechanism, the heat sink 2 was constituted of metal, and thus the excitation beam did not pass through. Thus, the excitation beam reflecting mechanism was arranged on a right side of the laser medium 28 of FIG. 8. Due to this, there was a need to avoid interference between the output coupler 32 and the excitation beam reflecting mechanism, and thus a distance between the output coupler 32 and the laser medium 28 could not have been shortened. The distance between the output coupler 32 and the laser medium 28 affects a resonator length of a laser oscillator. If the resonator length is long, it becomes difficult to shorten pulse time for the pulse laser and increase peak power, for example. According to the present embodiment, the excitation beam reflecting mechanism can be arranged on the left side of the laser medium 28 of FIG. 8, and the distance between the output coupler 32 and the laser medium 28 can freely be designed. The pulse time for the pulse laser can be shortened and the peak power can be increased.

### Fourth Embodiment

An embodiment of FIG. 11 is an excitation beam multi-reflection pulse laser apparatus provided with both the excitation both the excitation beam reflecting mechanism of FIGS. 8 to 10 and the Q switch of FIG. 1. Duplicating explanations on matters that were already explained will be omitted. In the present embodiment, the end coat 30 is intervened between the laser medium 28 and the saturable absorber 10. A layer having a high reflectance to the excitation beam and a low reflectance to the laser beam is used as the end coat 30. Further, the laser medium 28 and the saturable absorber 10 may be room temperature bonded. In this case, the end coat 30 is vapor deposited on one of the laser medium 28 and the saturable absorber 10, a layer constituted of a same material as the other of the laser medium 28 and the saturable absorber 10 is vapor deposited on a surface of the end coat 30, and the laser medium 28 and the saturable absorber 10 are thereby room temperature bonded. As a result, a layer constituted of the same material as the laser medium 28 is formed between the end coat 30 and the laser medium 28, or alternatively a layer constituted of the same material as the saturable absorber 10 is formed between the end coat 30 and the saturable absorber 10.

### Fifth Embodiment

An embodiment of FIG. 12 is provided with the excitation beam reflecting mechanism of FIGS. 8 to 10, and has a film 34 that functions as an end coat as well as an output coupler is provided at the end surface of the laser medium 8. Due to this, a configuration of a laser apparatus that discharges continuous laser beam can be simplified. In case of FIG. 12, a heat sink that is not shown may be joined to a right-side end surface of the film 34. The laser medium 28 can thereby be cooled from its both end surfaces.

The inventors have been studying techniques for high outputs of laser apparatus, and have come to a point of achieving a laser beam intensity of 50 GW/cm² or more. With such a high intensity, a contact condition between a laser medium and a heat sink is very important. Various known bonding techniques cause problems in increasing output power of the laser beam. According to the known bonding techniques, the laser medium is not efficiently cooled by the heat sink, high thermal stress is developed within the laser medium, or blur or coloring is generated at a joint interface of the laser medium and the heat sink. High transparency at the joint interface is critical in increasing laser power, since blur or coloring at the interface absorbs a part of the laser beam and generate heat at the interface. The amount of absorbed energy will be very high when the laser beam intensity is at 50 GW/cm² or more, even if blur or coloring is slight and the absorbing rate thereby is low. The description herein teaches a way to overcome the problems which prevent from increasing the laser power.

While specific examples of the present invention have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

What is claimed is:

1. A method of manufacturing a laser apparatus which includes a laser medium having an end surface and configured to emit light when excitation beam enters the laser medium, and a heat sink having an end surface and a higher thermal conductivity than the laser medium and configured to allow the excitation beam to permeate, the end surface of the laser medium being joined with the end surface of the heat sink, the method comprising:
forming an end coat on the end surface of one of the laser medium and the heat sink;
forming a same-material layer on a surface of the end coat, the same-material layer being constituted of a same material as another of the laser medium and the heat sink;
activating a surface of the same-material layer and the end surface of the other of the laser medium and the heat sink in a substantially vacuum environment; and
joining the activated surface of the same-material layer and the activated end surface of the other of the laser medium and the heat sink in the substantially vacuum environment.

2. A laser apparatus comprising:
a laser medium having an end surface and configured to emit light when excitation beam enters the laser medium;
a heat sink having an end surface and a higher thermal conductivity than the laser medium, configured to allow the excitation beam to permeate, the end surface of the laser medium being joined with the end surface of the heat sink;
an end coat provided between the heat sink and the laser medium; and
a same-material layer intervened between the end coat and one of the heat sink and the laser medium, the same-material layer being constituted of a same material as the one of the heat sink and the laser medium but having a different crystalline state.

3. The laser apparatus according to claim 2, further comprising:
a saturable absorber having an absorbing ability that is configured to saturate when an intensity of light entering from the laser medium increases, wherein
the heat sink comprises a first heat sink having a higher thermal conductivity than the laser medium and configured to allow the excitation beam to permeate, and a second heat sink having a higher thermal conductivity than the saturable absorber and configured to allow laser beam to permeate,
the first heat sink, the laser medium, the saturable absorber, and the second heat sink are arranged in this order,
a second end surface of the first heat sink joins a first end surface of the laser medium, a second end surface of the laser medium joins a first end surface of the saturable absorber, and a second end surface of the saturable absorber joins a first end surface of the second heat sink,
the end coat comprises a first end coat provided between the first heat sink and the laser medium, and a second end coat provided between the saturable absorber and the second heat sink,
the same-material layer comprises a first same-material layer intervened between the first end coat and one of the first heat sink and the laser medium, and a second same-material layer intervened between the second end coat and one of the saturable absorber and the second heat sink,
the first same-material layer is constituted of a same material as the one of the first heat sink and the laser medium but has a different crystalline state, and
the second same-material layer is constituted of a same material as the one of the saturable absorber and the second heat sink but has a different crystalline state.

4. The laser apparatus according to claim 2, wherein
the laser apparatus comprises the heat sink in plurality and the laser medium in plurality,
each of the heat sinks and each of the laser media are arranged alternately,
each of the laser media is configured to emit laser beam when the excitation beam enters, and
each of the heat sinks has a higher thermal conductivity than each of the laser media, and the excitation beam and the laser beam penetrate the heat sinks.

5. The laser apparatus according to claim 4, wherein
each of the laser media is configured to receive the excitation beam and input beam to discharge amplified beam of the input beam.

6. The laser apparatus according to claim 5, wherein
each of the laser media is configured to receive the excitation beam and input beam to emit output beam with amplified power of the input beam,
an incident direction of the excitation beam and a light emitting direction of the laser beam are same, and
the incident direction of the excitation beam and an incident direction of the input beam are opposite.

7. The laser apparatus according to claim 4, wherein
a light emitting atom density in the laser medium located cross to an end surface where the excitation beam enters is lower than a light emitting atom density in the laser medium located far away from said end surface.

8. The laser apparatus according to claim 2, further comprising:
an excitation beam reflecting mechanism,
wherein the citation beam reflecting mechanism is configured to reflect the excitation beam, which is permeating through the heat sink after having reflected in the laser beam, to direct the excitation beam to permeate through the heat sink towards the laser medium.
